(19) United States
(12) Patent Application Publication
(10) Pub. No.: US 2020/0079137 A1
(43) Pub. Date: Mar. 12, 2020

(54) FLEXIBLE SELF-STICKING MOSAIC TILE AND METHOD FOR MANUFACTURING SAME

(71) Applicant: Terry Greene, Stevenson Ranch, CA (US)

(72) Inventor: Terry Greene, Stevenson Ranch, CA (US)

(21) Appl. No.: 16/567,945

(22) Filed: Sep. 11, 2019

Related U.S. Application Data
(60) Provisional application No. 62/729,892, filed on Sep. 11, 2018.

(51) Int. Cl. B44C 3/12; B28B 1/28; B28B 7/00

(52) U.S. Cl. CPC B44C 3/123; B28B 7/00; B28B 1/28

(57) ABSTRACT

Flexible mosaic tiles and methods for manufacturing same are disclosed. A mold cavity of a mold element may have a cavity floor, a facing edge, perimeter wall surfaces extending therebetween, and a cavity volume. A layer of gel medium may be applied to the perimeter wall surfaces and allowed to dry. A volume of pouring medium is poured into the mold cavity. A volume of one or more fluid pigments is inserted into the mold cavity. The volume of pouring medium and the volume of fluid pigment are blended together. The blended volumes are allowed to set for a setting period. The blended volumes cure for a curing period in a curing environment, thereby forming a mosaic tile. The mosaic tile is removed from the mold cavity. A peel-and-stick backing may be applied to the rear of the mosaic tile for facilitating attachment of the mosaic tile to a substrate.

### RELATED APPLICATIONS

This application claims the benefit of U.S. Provisional Application No. 62/729,892 filed Sep. 11, 2018, the content of which is incorporated by this reference in its entirety for all purposes as if fully set forth herein.

### TECHNICAL FIELD

The present disclosure relates generally to mosaic tiles. More particularly, the present invention relates to mosaic tiles and methods of manufacturing same.

### BACKGROUND

Mosaic art and traditional mosaic materials have been around for thousands of years. For centuries, many artists have produced mosaic artwork and jewelry using all kinds of natural materials. As a longtime admirer, I attempted to create mosaics on my own. I tried various methods but struggled with it. I wanted that look of real stone and glass, but the materials were so heavy and sharp, and I'd often cut myself in the process. I also struggled with using tile cutting tools and it was even harder for me to use thin-set and grout, which were messy.

I set out to find a mosaic material that looked like glass and stone, but was lightweight, wouldn't cut my hands up and didn't require special tools, thin-set or grout. I searched but could not find any existing such product on the market, so I decided to create my own.

### SUMMARY

Certain deficiencies of the prior art of mosaic tiles and their production are solved by the teachings provided in the present disclosure.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic flow chart illustrating one non-limiting example method of manufacturing a flexible mosaic tile in accordance with the present disclosure;

FIG. 2 is a diagrammatic cross-sectional view of one non-limiting example of a mold element in accordance with the present disclosure, wherein a gel medium is shown applied to the perimeter wall surfaces of the respective mold cavity;

FIG. 3 is a diagrammatic cross-sectional view of one example of a flexible mosaic tile in accordance with the present disclosure;

FIG. 4 is a diagrammatic perspective view illustrating an example of a volume of pouring medium being poured into the mold cavity;

FIG. 5 is a diagrammatic perspective view illustrating an example of a volume of first fluid pigment being inserted into the mold cavity with the volume of pouring medium already present therein;

FIG. 6 is a diagrammatic perspective view illustrating an example of a volume of second fluid pigment being inserted into the mold cavity with the volume of pouring medium already present therein;

FIG. 7 is a diagrammatic perspective view illustrating an example step of blending together of the volume of pouring medium and the volume of fluid pigment;

FIG. 8 is a diagrammatic perspective view illustrating an example step of a removal of the post-cured mosaic tile from the mold cavity;

FIG. 9 is a diagrammatic perspective view of one example of a flexible mosaic tile manufactured in accordance with the present disclosure having been removed from the corresponding mold cavity;

FIG. 10 is a diagrammatic perspective view illustrating an example application of a peel-and-stick backing to a rear face of the flexible mosaic tile in order to render the mosaic tile self-sticking;

FIG. 11 is a diagrammatic perspective view illustrating the application of a brand label to the peelable layer of the peel-and-stick backing;

FIG. 12 is a diagrammatic perspective view illustrating an example flexible mosaic tile in accordance with the present invention including a peel-and-stick backing and brand labeling;

FIG. 13 is a diagrammatic perspective view illustrating the tile perimeter edges being trimmed to align with the corresponding lateral edges of the peel-and-stick backing; and

FIG. 14 is a diagrammatic top-front perspective view illustrating an example flexible self-sticking mosaic tile in accordance with the present invention.

### DETAILED DESCRIPTION OF THE PREFERRED EMBODIMENTS

Referring now to the drawings, like reference numerals designate identical or corresponding features throughout the several views.

In initially attempting to solve the deficiencies of the prior art, I started out using regular acrylic craft paints and acrylic fluid mediums like glaze or varnish and pouring them into a small plastic mold where they could dry in a specific shape. For example, I used a ratio of 25-35% acrylic fluid medium to 65-75% craft paint. The craft paints have a consistency similar to icing or peanut butter and this made the tiles too thick and caused “crazing” in the tiles, giving them a dull, uneven, and lumpy looking surface once dried. This also caused the tiles to take a full 7 days to dry into a solid, but flexible, form. Initially, I left them to dry on a flat surface, such as a table, and didn't pay much attention to the air temperature, which led to very inconsistent results. The tiles were also rather thick at ⅛″ to ½″, making them really tough to cut with scissors. They also still required use of some type of adhesive to mount to a substrate. Moreover, some of the paints seemed to resist the plastic molds, causing uneven distribution of color. That process was unsuccessful, so I continued experimenting. This experimentation led to improvements in manufacturing methods, and the resulting tile, which form part of the present disclosure.

By way of example only, my many experiments led me to take the following approaches in certain implementations of the method of manufacturing tiles, which yielded tiles with certain favorable properties:

By way of a first example, in cases in which I stopped using the thicker craft paints and switched to using higher quality fluid acrylic paints and inks (brands available include Golden and Dr. Martins), this created tiles with a more vibrant color and eliminated the crazing issue.

By way of a second example, in cases in which I started using acrylic pouring medium (brands available include Liquitex and Nova Color) instead of acrylic glaze or varnish, this, in combination with the high fluid acrylic paints and inks, produces a much smoother consistency with an even, glass-like surface that better resembles glass and stone tiles.

By way of a third example, in cases in which I altered the ratios of acrylic medium to acrylic paints and inks so that the mixture includes a ratio of 35-80% of the pouring medium and 25-50% of the fluid acrylic paint/inks, this mixture made for a more consistent outcome, a more realistic looking mosaic tile and a thinner tile that is much easier to cut. For example, the tiles could now be now be made to be 1/16″ in thickness.

By way of a fourth example, I solved the issue of some acrylic pigments resisting from the sides of the mold by first adding a thin layer of a gel medium (brands available include Golden or Liquitex) to the inner sides of the mold and allowing it to dry before adding the fluid components. By implementing this solution, the fluid pigments now actually gravitate towards the sides of the molds creating a more even distribution of the color within the resulting tile.

By way of a fifth example, I solved the issue of long drying times in part by switching to more fluid pigments and pouring medium, but mainly by establishing the proper temperature and drying method. For example, in certain preferred implementations of the manufacturing method, the tiles may need a humidity of 5-45% and air temps of 68-78 degrees and require air movement that can be provided by using an overhead fan in order to cure most efficiently. Air circulation may be helpful or critical. Additionally, drying the tiles on racks (such as conventional cookie racks) allows for more airflow so now the tiles can dry in 2-4 days.

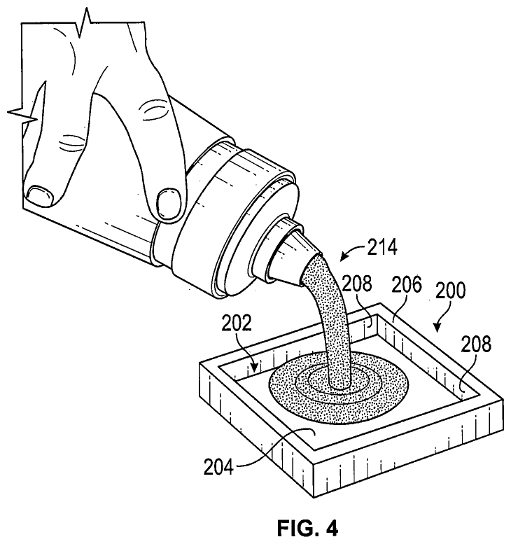

By way of a sixth example, in order to eliminate the reliance on using thin-set and grout, in certain preferred implementations of the manufacturing method, a sheet of double sided adhesive, cut for example into a 4-inch square of peel-and-stick backing (see, e.g., backing 226 in FIG. 3 with peel layer 228 and adhesive layer 230), may be applied to the back of each tile. This allows for the simple removal of the paper backing (see, e.g., peel layer 228 in FIG. 3) in order to adhere it to a surface of a substrate by way of the adhesive layer 230.

Certain preferred implementations of the improvements discussed above produce a tile 220 which may be generally characterized as a crafting material made from acrylic mediums, fluid acrylic artist paints along with acrylic and alcohol inks. The tiles may have the appearance of a traditional square glass, stone or ceramic tile. They may be bendable, may feature a peel and stick backing 226, and can be cut with scissors (see, e.g., FIG. 13) into various shapes that can be used to create arts and crafts projects such as mosaics and even jewelry. Certain preferred embodiments of the tiles 220 manufactured in accordance with the present disclosure may be, for example, approximately 4-inch square and approximately 1/16 inch thick.

One example of a set of materials which may be gathered for use in implementing a tile manufacturing method in accordance with the present disclosure are as follows: (a) Square silicone molds (for example, with mold cavity dimensions of approximately 4×4 inches laterally and about ½″ deep); (b) Drying racks (for example, stacking cookie racks or similar); (c) Acrylic Pouring Medium (example brands available include Nova and Liquitex); (d) Gel Medium (example brands available include Golden and Liquitex); (e) Fluid acrylic pigments (for example, highly fluid paints and inks; brands available include Golden & Dr. Martins); (f) Mixed media additives (such as glitter or cut up pieces of already-made tiles); (g) Double-sided adhesive sheets cut into, for example, 4-inch squares (example brands available include 3M® and Graphix); (h) Stir sticks or popsicle sticks for blending (available at any craft store); (g) The tile recipe (for example, a specific set of pigments, mixing styles and ratios designed to produce a tile with particularly colors and patterns).

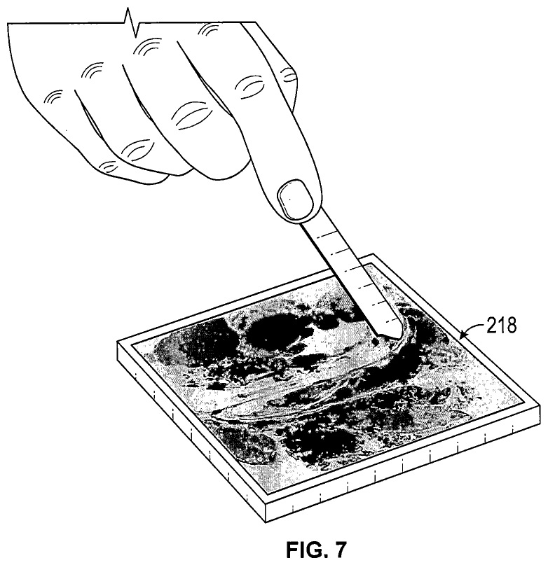

The following is one non-limiting example of a method of manufacturing flexible mosaic tiles in accordance with the present disclosure, and is particularly adapted for using the specific set of materials described above. The mold cavity 202 may first be prepped by spreading a layer of gel medium, using for example a popsicle stick, all along the inner sides (perimeter wall) of the mold cavity 202, taking care not to get it on the bottom (cavity floor 204) of the mold 200. This is done to prevent pigments from resisting the silicone mold. Must dry before proceeding. This ensures even distribution of pigment color during drying process. Depending on the pigments that will be added, each mold cavity 202 may be filled with, for example, about 35-80% of pouring medium 214. The entire contents of each tile (e.g., pouring medium 214 and pigments 216) should preferably fill only ¾ or less of the mold cavity 202. Single pigments and thicker pigments may require a higher ratio of pouring medium 214. Multiple pigments and thinner or highly fluid metallics require a lower ratio of pouring medium 214. If the tile recipe calls for cut up pieces of tile, it is usually added at this time. If a glitter additive is to be used, it may optionally be mixed in with the desired pigments 216 in the next step. Immediately following that, fill to that maximum level (the remaining 40-60% of fluid) with the desired pigment(s). Then the two mediums get mixed together using a marbleized (see, e.g., marbleization 218 in FIG. 7) or fully-blended mixing method, depending on what that tile recipe calls for. If the tile recipe calls for glitter, it may be added at this time. For example, the glitter may be sprinkled on top of the constituents already present in the mold cavity. Once the tile has been poured and blended, it needs to set in place for approximately 4-6 hours before it can be moved to a drying rack where it will complete its curing process. The temperature in the drying space should preferably be maintained between 68-78 degrees with a humidity level maintained from 5-45%, and there should preferably be a fan circulating the air. After a sufficient dry time (e.g., three days), lift the corners of each tile to ensure it's completely dried. If they don't lift cleanly, the tile may need another twenty-four (or more) hours to finish drying. Once totally dry, each tile gets removed from its mold. Once out of the mold, the tile is flipped over and a 4×4 inch (or other appropriate size) square of the peel and stick backing 226 is applied to the rear face 222 of the tile, taking care to minimize air bubbles being trapped between the backing and the tile. Once the backing is attached, trim each around the edges of the tile (see, e.g., tile perimeter edge 224 in FIG. 13) to clean it up and match up with the shape of the backing. At this point the tiles are ready to package, sell or use.

Using the supplies and processes listed above to manufacture tiles 220 in accordance with the present disclosure, each tile precursor (pre-cured mix of constituents) may take approximately two minutes to create and approximately three days to dry (cure) before the resulting tile is ready to be released from the respective mold. Applying the peel & stick backing, and trimming the tile around the backing, may take another approximately 1.5 minutes per tile.

In certain preferred embodiments in accordance with the present disclosure, by using a liquid formulation made from fluid acrylic paints and inks in combination with an acrylic pouring medium, a flexible mosaic tile 220 may be manufactured that is lightweight, bendable, free of sharp edges, can easily be cut with regular scissors and has a peel and stick backing 226 for mounting the tile to a substrate, all while looking just like real glass and stone.

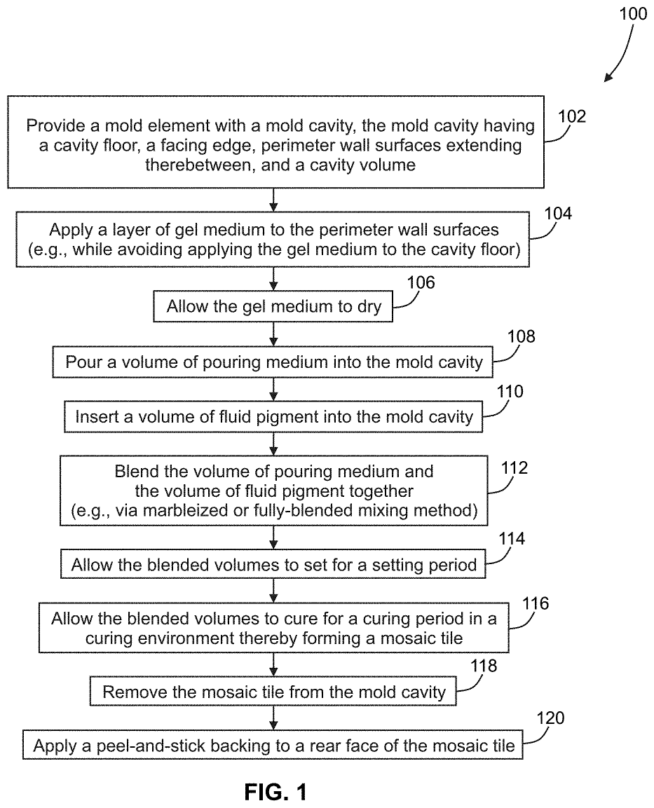

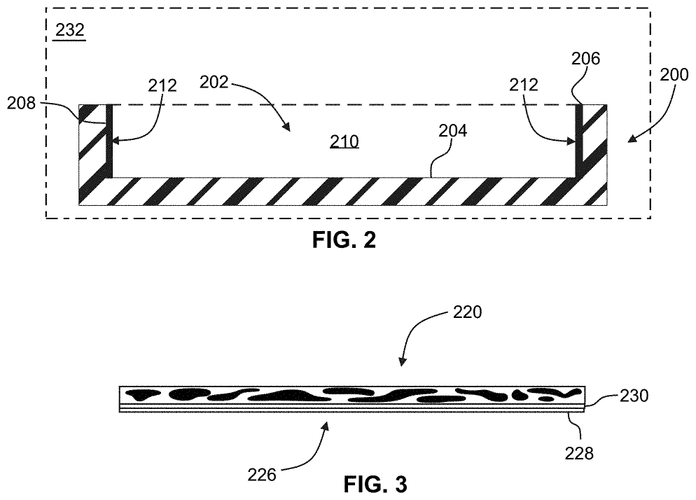

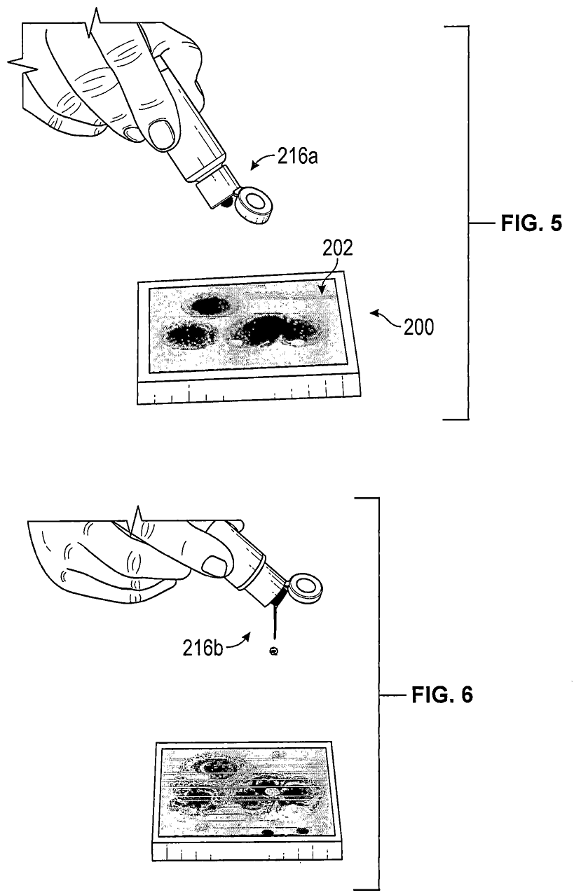

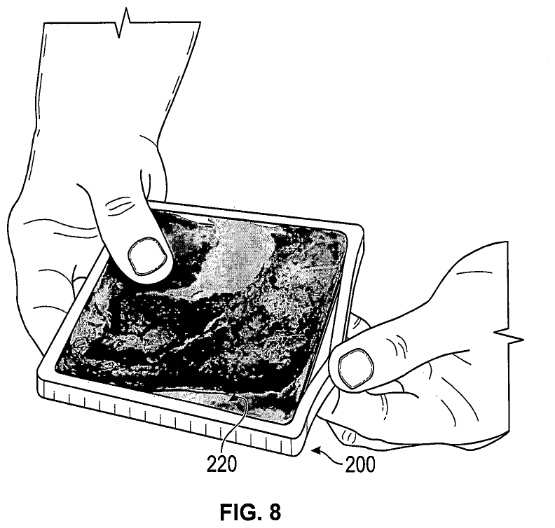

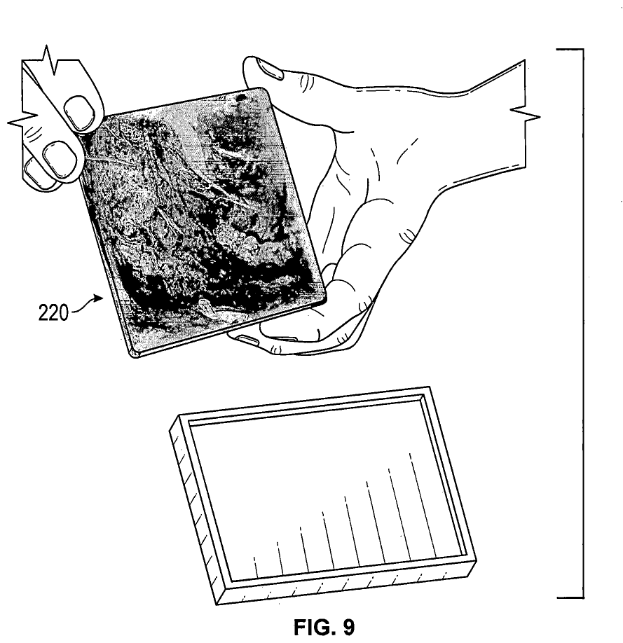

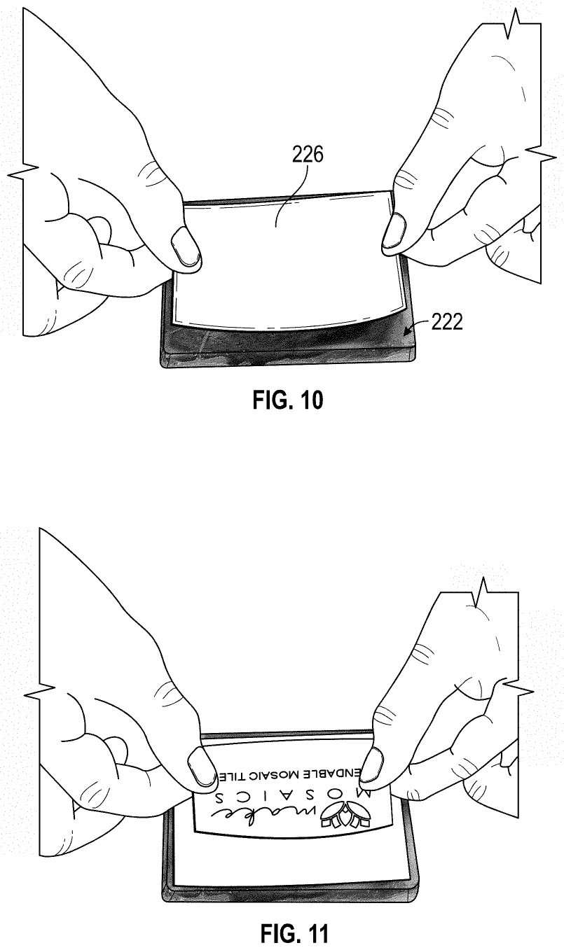

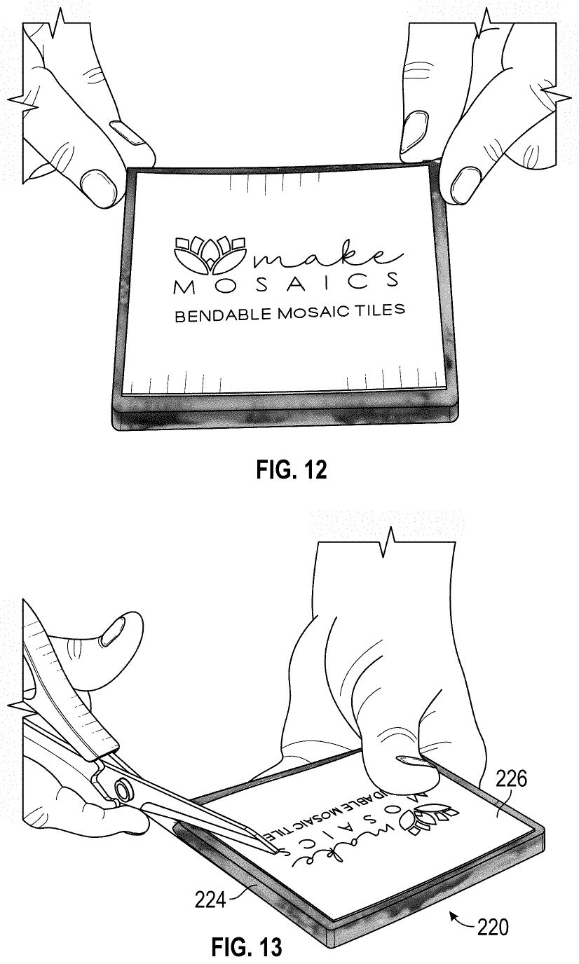

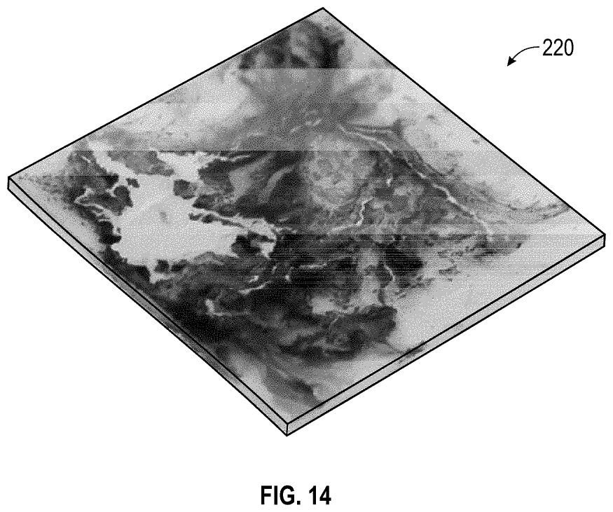

One example method for manufacturing a flexible mosaic tile in accordance with the present invention is shown at 100 in FIG. 1. The potential steps in the example method 100 are illustrated at blocks 102-120. Examples of components referred to in the discussion of this method are illustrated in FIGS. 2-14. At block 102 of the method 100, a mold element 200 with a mold cavity 202 is provided. Referring to FIG. 2, the mold cavity 202 may preferably have a cavity floor 204, a facing edge 206, perimeter wall surfaces 208 extending therebetween, and a cavity volume 210. At block 104 of the method 100, a layer of gel medium 212 may be applied to the perimeter wall surfaces 208, and at block 106, allowed to dry. At block 108 of the method 100, and referring to FIG. 4, a volume of pouring medium 214 may be poured into the mold cavity 202. At block 110 of the method 100, and referring to FIGS. 5 and 6, a volume of fluid pigment 216 (e.g., 216a, 216b, and/or addition fluid pigments) is inserted into the mold cavity 202. At block 112 of the method 100, and referring to FIG. 7, the volume of pouring medium 214 and the volume of fluid pigment 216a may be blended together. At block 114 of the method 100, the blended volumes (e.g., of medium 214 and fluid pigment 216a) may preferably be allowed to set for a setting period. At block 116 of the method 100, the blended volumes are allowed to cure for a curing period in a curing environment, thereby forming a mosaic tile. At block 118 of the method 100, and referring to FIG. 9, the formed mosaic tile 220 is removed from the mold cavity 202. Referring to FIGS. 1 and 10, at block 120 of the method 100, a peel-and-stick backing 226 (or the like) may preferably be applied to a rear face 222 of the mosaic tile 220 after the step of removing. The flexible mosaic tile with peel-and-stick backing (or the like) is rendered self-sticking, in that it is capable of being affixed to a substrate such as a wall or backing board without requiring the use of special tools, thin-set or grout, or the like.

In particular embodiments of the method 100, the mold element 200 is comprised of silicone. Moreover, the step of applying a layer of gel medium 212 may include avoiding applying the gel medium 212 to the cavity floor 204.

In certain embodiments of the method 100, the pouring medium 214 is an acrylic pouring medium.

In particular embodiments of the method 100, the step of blending (see block 112) employs a marbleized mixing method. Alternatively, the step of blending may employ a fully-blended mixing method.

In certain embodiments of the method 100, the curing environment 232 may have a temperature maintained between 68 and 78 degrees F. Moreover, the curing environment 232 may have a humidity level maintained from 5% to 45%. Furthermore, the curing environment 232 may preferably include circulated air.

In particular embodiments of the method 100, the setting period may be 4-6 hours. Additionally, or in the alternative, the curing period may preferably be 2-4 days.

In certain embodiments of the method 100, (a) a fill volume may be defined as a portion of the cavity volume 210, (b) the volume of pouring medium 214 may be 40-60% of the fill volume, and (c) the volume of fluid pigment (e.g., 216a and/or 216b) may be 35-80% of the fill volume. In particular such embodiments, the fill volume may preferably be less than ¾ of the cavity volume 210.

In particular embodiments of the method 100, (a) a fill volume may be defined as a portion of the cavity volume 210; (b) the volume of pouring medium 214 may be 35-80% of the fill volume; and (c) the volume of fluid pigment may be 25-50% of the fill volume.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for manufacturing a flexible mosaic tile, the method comprising:
providing a mold element with a mold cavity, the mold cavity having a cavity floor, a facing edge, perimeter wall surfaces extending therebetween, and a cavity volume;
applying a layer of gel medium to the perimeter wall surfaces;
allowing the gel medium to dry;
pouring a volume of pouring medium into the mold cavity;
inserting a volume of fluid pigment into the mold cavity;
blending the volume of pouring medium and the volume of fluid pigment together;
allowing the blended volumes to set for a setting period;
allowing the blended volumes to cure for a curing period in a curing environment, thereby forming a mosaic tile; and
removing the mosaic tile from the mold cavity.

2. A method as defined in claim 1 further comprising
applying a peel-and-stick backing to a rear face of the mosaic tile after the step of removing.

3. A method as defined in claim 1 wherein the mold element is comprised of silicone.

4. A method as defined in claim 3 wherein the step of applying a layer of gel medium includes avoiding applying the gel medium to the cavity floor.

5. A method as defined in claim 1 wherein the pouring medium is an acrylic pouring medium.

6. A method as defined in claim 1 wherein in the step of blending employs a marbleized mixing method.

7. A method as defined in claim 1 wherein in the step of blending employs a fully-blended mixing method.

8. A method as defined in claim 1 wherein the curing environment has a temperature maintained between 68 and 78 degrees F.

9. A method as defined in claim 8 wherein the curing environment has a humidity level maintained from 5% to 45%.

10. A method as defined in claim 9 wherein the curing environment includes circulated air.

11. A method as defined in claim 1 wherein the setting period is 4-6 hours.

12. A method as defined in claim 1 wherein the curing period is 2-4 days.

13. A method as defined in claim 1 wherein
(a) a fill volume is defined as a portion of the cavity volume;
(b) the volume of pouring medium is 40-60% of the fill volume; and
(c) the volume of fluid pigment is 35-80% of the fill volume.

14. A method as defined in claim 13 wherein the fill volume is less than ¾ of the cavity volume.

15. A method as defined in claim 1 wherein
(a) a fill volume is defined as a portion of the cavity volume;
(b) the volume of pouring medium is 35-80% of the fill volume; and
(c) the volume of fluid pigment is 25-50% of the fill volume.
